(19) United States
(12) Patent Application Publication
(10) Pub. No.: US 2003/0221129 A1
(43) Pub. Date: Nov. 27, 2003

(54) Save and compare method to detect corruption of WWW pages

(76) Inventor: Petr Hejl, White Rock (CA)

Correspondence Address: Vermette & Co., Granville Square, Suite 230, 200 Granville Street, Box 40, Vancouver, BC, V6C 1S4, CA

(21) Appl. No.: 10/445,229

(22) Filed: May 27, 2003

(30) Foreign Application Priority Data
May 24, 2002 (CA) 2,387,324

(51) Int. Cl. G06F 12/14; G06F 11/30; H04L 9/32; H04L 9/00; G06F 9/00

(52) U.S. Cl. 713/201

(57) ABSTRACT

A Save and Compare method for protecting WWW pages. With this method, parts of the pages can be selected, which are not checked; or time intervals can be defined, when the pages are not checked. The differentiation between legitimate and illegitimate change is performed automatically or semiautomatically.

### FIELD The present invention relates to a method of detecting corruption of WWW pages.

### BACKGROUND

WWW pages may be corrupted for several reasons, such as by a hardware error, a software bug, a hacker, a virus, etc. Existing methods to protect WWW pages can be divided into three groups:

1. Preventative Methods

Preventative methods include restrictions as to who may change the WWW pages, what in them may be changed, when they may be changed and how they may be changed. For example, changes could be restricted to only persons with a permitted user name and password. Alternatively or additionally pages may be changed only from a specific computer in the network. Programs or data with specific (virus) patterns are detected and prevented from being inserted into the WWW pages.

2. Detecting Methods

The goal is to detect the corruption of WWW pages as soon as possible. E.g. these methods search for shameful expressions (inserted by hackers) or suspicious sequences (viruses patterns) in WWW pages. Alternatively, these methods remember some characteristics of the WWW pages (text, images, length, control sum . . . ) for later comparison.

3. Healing Methods

When corruption is detected, the good (original) status of the WWW pages is restored by these methods.

Existing detecting methods exhibit the following problems:

1. Inconvenient for Dynamic Pages

Many WWW pages are dynamic, i.e. they are changed by their owners (webmasters, network masters, programs . . . ), e.g. for different visitors, with news or in time. Different visitors may have generated different advertising banners. The page changes with every new item of news published on it, or the pages may change hourly, daily, etc. If is impractical to detect and announce every change of a dynamic page.

2. Hard Differentiation

When the WWW page is changed, it is rather difficult to differentiate, whether the change was legitimate, done by the owner (webmaster, network master . . . ), or illegitimate, (done by hacker or virus). For example, the word “pig” may be OK on some agricultural pages, but have quite another meaning on political pages. Or, in contrast to computer programs, there are no virus patterns for WWW pages or only badly defined ones.

### SUMMARY OF THE INVENTION

SC method is a new method to detect corruptions of WWW pages. In the following SC is the abbreviation for “Save and Compare”.

The WWW pages are saved, and the sample is made. Parts of the pages may be selected, which will not be compared, or time intervals may be selected, when the whole pages will not be compared. In defined time intervals the WWW pages are compared with the sample. Changes are evaluated automatically or judged by a person. If the change is illegitimate, action is taken: the change is announced to the owner (webmaster, network master . . . ) of the pages and/or the original status is restored (from the sample).

### DETAILED DESCRIPTION WITH REFERENCE TO THE DRAWINGS

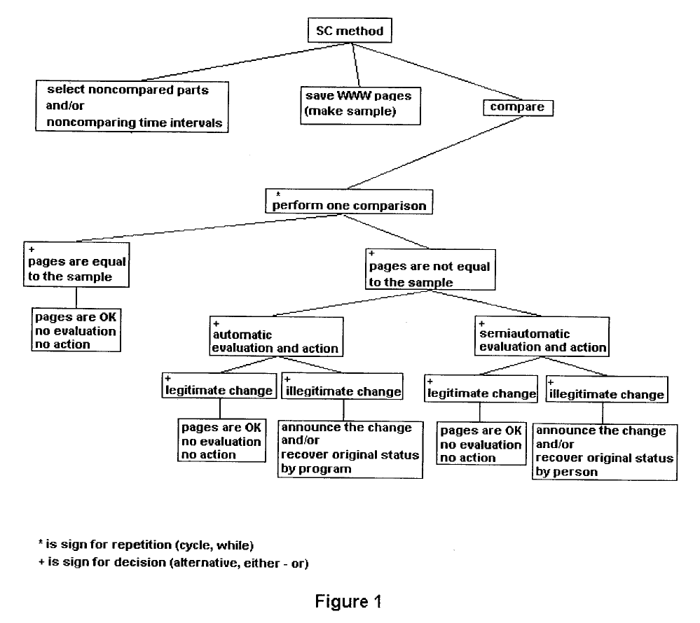

Referring to FIG. 1 the SC (Save and Compare) method 10 has following characteristics:

1. External

Saves WWW pages in an external way, like a browser, and does not require access into the inside the servers.

2. Suitable for Static and Dynamic Pages

On WWW pages, parts may be selected, which are not compared, or time intervals may be selected, when the whole pages are note compared (may be changed). The uncompared parts of WWW pages are just the parts, which are (frequently) changed. On most dynamic WWW pages such restricted parts can be defined. These small parts are not checked (which is a risk), but on the other hand just this “restricted nonchecking” enables the usage of the SC method for dynamic pages (and so this small risk can be accepted).

3. Automatic or Semiautomatic

Automatic or semiautomatic evaluation of changes and recovery action can be performed.

Algorithm

1. Select Noncompared

Referring to FIG. 1, at 12 parts of the pages may be selected, which will not be compared, or time intervals may be selected, when the whole pages will not be compared.

2. Save

At 14 WWW pages are saved and a sample is made. It is expected, usually verified by the owner (webmaster, network master . . . ) or by the worker of the company providing the SC method, that the pages are OK, when saving them. Texts, images, melodies, and other files from the WWW page are usually saved.

3. Compare

At 16 in defined time intervals, the WWW pages are compared with the sample, one such comparison being made at 17. Selected parts of the pages are not compared and/or the whole pages are not compared within selected intervals. At 18 when the pages are equal to the original pages, they are OK. At 20 when the pages are different, evaluation and action follows.

4. Evaluation and Action

There are two possible evaluation and actions, depending on the page's owner's (webmaster's, network master's . . . ) decision: automatic 22 or semiautomatic 24.

4.1 Automatic

The page is searched for hacking traces (shameful expressions, pictures . . . ), viruses, . . . , automatically evaluated by program, whether the change is legitimate 26 or not 28, the evaluated illegitimate change is announced to the page's owner and/or the original status of the page is restored.

4.2 Semiautomatic

The change is announced to an internal worker of the company providing the SC method. This worker views the pages and judges, whether the change is legitimate 30, or illegitimate 32.

When the change is legitimate, the WWW pages are OK.

In the case of illegitimate change, the worker either announces the change of the WWW pages to the owner (webmaster, network master . . . ) and/or restores the pages, i.e. restores the good (original) status of the pages (from the sample).

Remarks

1. Noncompared Parts

With the noncompared parts it is expected, that they will form only a small part of the WWW pages.

2. Nonfunctionality Detection

Of course, the SC method will detect and announce the nonfunctionality of the WWW pages, caused by such problems as connection interruption, server fallout, etc. It is a “side effect” of the SC method, and nonfunctionality is detected whenever the WWW pages are saved.

3. Automatic or Semiautomatic

The owners (webmasters, network masters . . . ) themselves will decide, whether they order automatic or semiautomatic service. For static or low dynamic pages (not changing or little changing), the automatic service will most likely be sufficient. For high dynamic pages (frequently changing, in many parts or for many times), the semi automated service will be more suitable. The automatic service will be cheaper, but the owner (webmaster, network master . . . ) will get some number of “false positive” announcements. The semiautomatic service will be more expensive, but the owner (webmaster, network master . . . ) will get mostly only “real corruption” announcements.

4. Communication Ways

The announcements may be done by suitable communication way (s) such as the following: phone, fax, email, SMS, etc. The most convenient way seems to be SMS messaging for the following reasons:

the mobile network is (highly) independent on the Internet

the owners (webmasters, network masters . . . ) may take their mobile phones wherever they go.

I claim:

1. A method of protecting WWW pages, comprising
(a) saving the WWW pages to be protected to make a sample;
(b) choosing selected parts of the WWW pages which will not be compared and time intervals in which the whole of the WWW pages will not be compared;
(c) comparing parts of said WWW pages other than said selected parts and WWW pages outside of said one time interval for comparison with said sample;
(d) evaluating any changes to detect hacking traces and illegitimacy;
(e) announcing said changes to a page owner; and
(f) restoring an original status of the WWW pages.

1. The method according to claim 1, wherein said evaluating step is done automatically.

2. The method according to claim 1, wherein said evaluating step is done manually in accordance with predefined criterion.
